(19) United States
(12) Patent Application Publication
(10) Pub. No.: US 2007/0142104 A1
(43) Pub. Date: Jun. 21, 2007

(54) Electronic device with a retractable antenna assembly

(76) Inventors: Ban Hin Ooi, Bayan Lepas (MY); Chong Chung Goh, Sungai Bakap (MY)

Correspondence Address: MOTOROLA, INC., 1303 EAST ALGONQUIN ROAD, IL01/3RD, SCHAUMBURG, IL, 60196, US

(21) Appl. No.: 11/304,292

(22) Filed: Dec. 15, 2005

(51) Int. Cl. H04M 1/00

(52) U.S. Cl. 455/575.7

(57) ABSTRACT

An electronic device (200) having a housing (205) with an end cap locator (210). There is a retractable elongate radio frequency radiating element (106) passing through an aperture associated with the end cap locator (210) the radiating (106) element being electrically connected to an electrical circuit provided in the housing (205) and being movable from a retracted position when substantially located in the housing (205) to an extended position when substantially protruding outside the housing (205). An end cap (104) is located on a free end of the radiating element, (106) the end cap (104) operatively engages the end cap locator (210) when the radiating element (106) is in the retracted position thereby aligning the end cap (204) in a predetermined orientation relative to the housing (205).

### FIELD OF THE INVENTION

The present invention relates generally to the field of electronic devices having a retractable antenna.

### BACKGROUND

Typically, wireless-communication devices, such as cellular telephones or personal digital assistants have include electronics, a housing containing the electronics, and some form of an antenna assembly for radiating and receiving radio-frequency (RF) signals that is physically mounted to the housing and electrically coupled with the electronics. For a personal, hand-held, wireless-communication device, a desirable antenna assembly has a physical size commensurate with the housing and typically moveable between a retracted position and an extended position relative the housing. When the device is to be stored in pocket, purse, or bag, the antenna is usually retracted to reduce the device's overall size.

The abovementioned antenna assemblies are often referred to as retractable or telescopic antennas and they have an end cap adjacent the tip of the antenna to facilitate easy extension and retraction of the retractable antenna. The end cap also functions as a cover for a helical, spiral or meandering radiator element that comprises part of the antenna. In general end caps are symmetrical about a longitudinal axis of an antenna and typically they cylindrical or semi-spherical. As such, there has been little or no compelling requirement to ensure that the antenna is aligned is a pre-desired oriented or when retracted into a housing of a device.

### SUMMARY OF THE INVENTION

According to one aspect of the invention there is provided an electronic device comprising: a housing with an end cap locator; a retractable elongate radio frequency radiating element passing through an aperture associated with the end cap locator, the radiating element being electrically connected to an electrical circuit provided in the housing and being movable from a retracted position when substantially located in the housing to an extended position when substantially protruding outside the housing; and an end cap located on a free end of the radiating element, the end cap operatively engaging the end cap locator when the radiating element is in the retracted position thereby aligning the end cap in a predetermined orientation relative to the housing.

### BRIEF DESCRIPTION OF THE FIGURES

In order that the invention may be readily understood and put into practical effect, reference will now be made to exemplary embodiments as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 illustrates a perspective view with partially cut away sections of a retractable antenna assembly in a retracted position and mounted to a circuit board in accordance with an embodiment of the invention;

FIG. 2 illustrates a right-side elevation view with a partially cut away section of an electronic device with the retractable antenna assembly of FIG. 1 in an extended position in accordance with an embodiment of the invention;

FIG. 3 illustrates a right-side elevation view of FIG. 2 with the retractable antenna assembly of FIG. 1 in a retracted position in accordance with an embodiment of the invention in accordance with an embodiment of the invention

FIG. 4 illustrates part of a second embodiment of part of an electronics device;

FIG. 5 illustrates part of a third embodiment of part of an electronics device;

FIG. 6 illustrates part of a fourth embodiment of part of an electronics device; and

FIG. 7 illustrates part of a fifth embodiment of part of an electronics device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of an electronic device and antenna assembly. Accordingly, the electronic device and antenna assembly. have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a electronic device and antenna assembly. that comprises a list of elements does not include only those elements but may include other elements not expressly listed or inherent to such electronic device and antenna assemblies. An element proceeded by “comprises . . . a” does not, without more constraints, preclude the existence of additional identical elements in the electronic device and antenna assembly.that comprises the element.

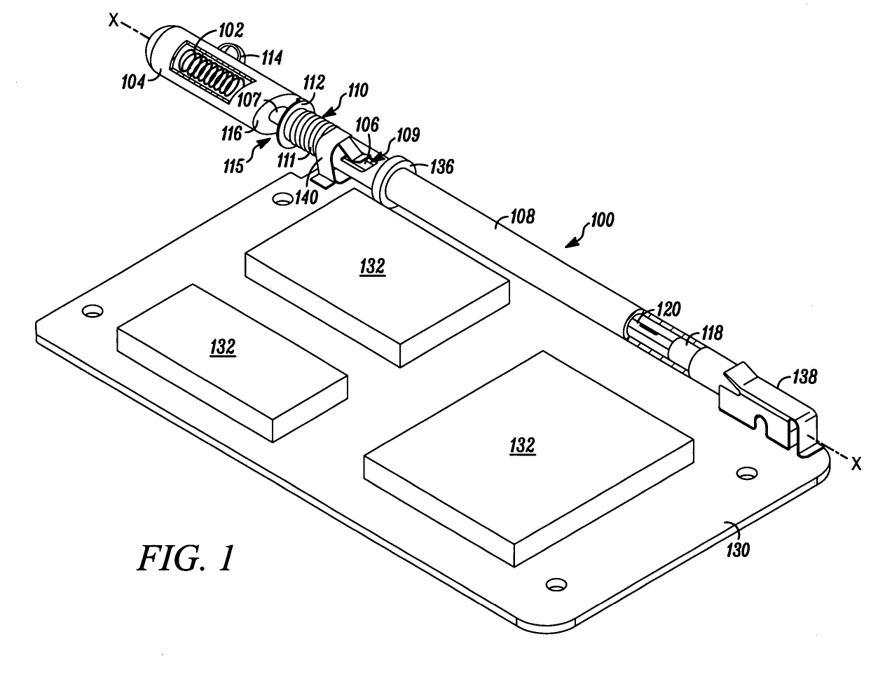

Referring to FIG. 1, there is illustrated a retractable antenna assembly 100 in a retracted position. The antenna assembly 100 has a helical radio frequency radiating element 102 enclosed in an end cap 104 and a linear retractable radio frequency radiating element 106 slidably captive in a ferrule 108 that has a bush 110 at one end.

The helical radiating element 102 is typically a compact, spiral-wound length of metal wire (or an etched meander on a circuit board substrate) and the linear retractable radiating element 106 is typically an elongate straight or tightly-wound length of metal wire that has a free end in direct physical and electrical contact with an end of the helical radiating element 102. Hence, the end cap 104 that encloses the helical radiating element 102 is also located at the free end 107 of the linear retractable radiating element 106 and to reduce shorting or signal interference the end cap 104 is an electrical insulator and linear radiating element 106 is covered with an electrical insulator such as a plastics paint or thin coating. Further, the end cap 104 has a protrusion 114 and at a base portion 115 of the end cap 104 there is a continuous first track 116. The continuous first track 116 is in a plane that is transverse to a central axis X of the linear radiating element 106, the central axis X being an axis along which linear radiating element 106 extends and retracts.

The ferrule 108 can be formed from a thin sheet of conductive material such as, nickel alloy, gold alloy, or copper alloy that at least partially surrounds the linear radiating element 106. The ferrule 108 defines a cylinder that holds captive an insulated end stop 118 that is mounted at an exposed end region 120 of the linear radiating element 106. In this regard the exposed end region 120 is not covered with an electrical insulator.

The bush 110 has an associated threaded portion 111 on its exterior surface and an associated flange 122. The bush 110 also has an aperture large enough to allow linear radiating element 106 to pass therethrough whilst disallowing passage of the end stop 118.

The antenna assembly 100 is mounted to circuit board 130 of a wireless-communication device by mounts 136 and 138. As will be apparent to a person skilled in the art, the circuit board 130 has electronic components 132 mounted thereon forming an electric circuit with a spring loaded feed-point contact 140. The feed-point contact 140 is mounted on circuit board 130 and is in slidable contact with the linear radiating element 106 through a notch (aperture) 109 in the ferrule 108 and thus the linear radiating element 106 is electrically connected to an electrical circuit.

The circuit board 130 further includes a ground plane (not shown) that is electrically coupled to the ferrule 108 by the mount 138, the mount 138 being typically formed from a metal or metal alloy and provides a ground path from first antenna assembly 100 to ground plane of the circuit board 130.

The feed contact point 140 provides electrical coupling between the antenna assembly 100 and circuit board 130 such that when the antenna assembly 100 is in a retracted position the feed contact point 140 touches an insulated section of the linear radiating element 106, and when the antenna assembly 100 in the fully extended position the feed contact point 140 touches the exposed end region 120 of the linear radiating element 106.

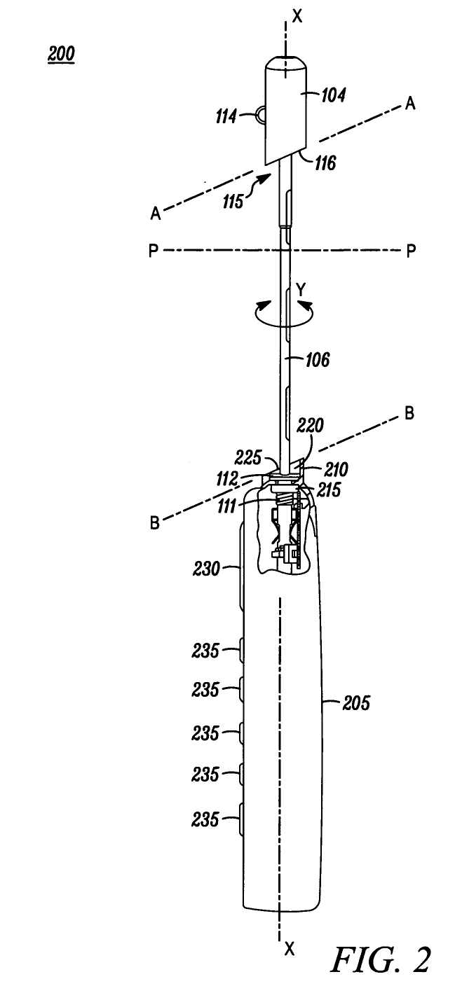

Referring to FIG. 2 there is illustrated an electronic device 200 comprising the retractable antenna assembly 100 when in an extended position. The circuit board 130 is mounted in a housing 205 of the device 200 and the housing 205 has an end cap locator 210 adjacent the flange 112. In this regard, the flange 112 on an outer surface of the housing and a nut 215 engaging threaded portion 111 on an inner surface of the housing 205 co-act to assist in mounting and the assembly 100 to the housing 205. The end cap locator 210 has an aperture 220 to allow the linear radiating element 106 to pass therethrough and retract and extend along axis X. as well as allowing linear radiating element 106 to rotate about axis X.as illustrated by arrowed line Y.

The end cap locator 210 has a continuous second track 225 having a complimentary shape to abut the first track 116 and the second track 225 is in a plane that is transverse to a central axis X. It will therefore be apparent to a person skilled in the art that both the first and second tracks 116, 225 are tapered at an angle to a plane P that is normal to the axis X and further both the first and second tracks 116, 225 are tapered, and have complementary shaped surfaces, that are at an angle transverse to axis x. The angle of the surface plane of track 116 is identified by plane A and the angle of the surface plane of track 225 is identified by plane B.

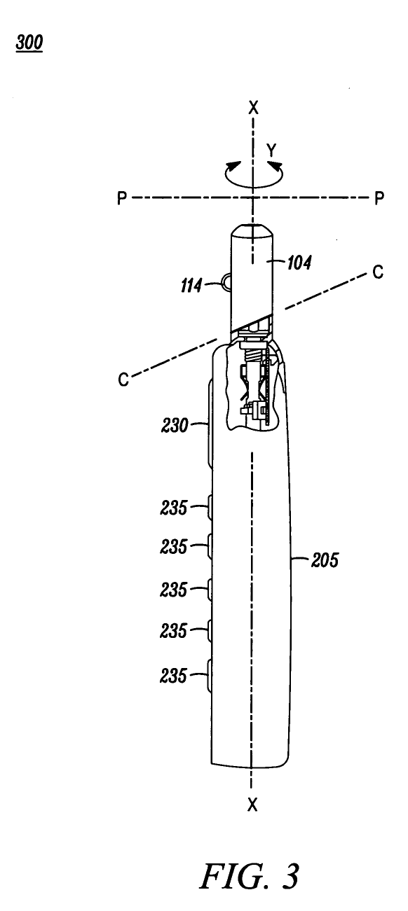

The linear radiating element 106 is moveable relative to housing 205 from the extended position to a retracted position. Referring to FIG. 3 there is illustrated the electronic device 200 comprising the retractable antenna assembly 100 when in the retracted position. During retraction to the retracted position the end cap 104 operatively engages the end cap locator 210 such that the continuous second track 225 that is complementary shaped to abut the continuous first track 116 co-acts when in abutting contact to provide a torque on linear radiating element 106. This torque is in the direction as illustrated by arrowed line Y and thereby performs aligning of the end cap 104 in a predetermined orientation relative to the housing 205. In this embodiment, the aligning of the end cap in the predetermined orientation is complete when continuous second track 225 abuts the continuous first track 116 along its full length so that plane A and plane B are coplanar as indicated by plane C. In this specific embodiment, the alignment in the predetermined orientation ensures that the protrusion 114 faces the same direction of as a display screen 230 and keys 235 of a keypad on a front face of the device 200. Thus, the invention ensures that the protrusion always faces the same direction when the antenna assembly 100 is in the fully retracted position relative to the housing 205. In other words, the antenna assembly is movable along the central axis X from a retracted position when substantially located in the housing 205 to an extended position when substantially protruded outside the housing 205. The end cap 104 that is located on a free end of the linear radiating element 106 operatively engages the end cap locator 210 when the radiating element 106 is in the retracted position thereby aligning the end cap 104 in the predetermined orientation relative to the housing 205.

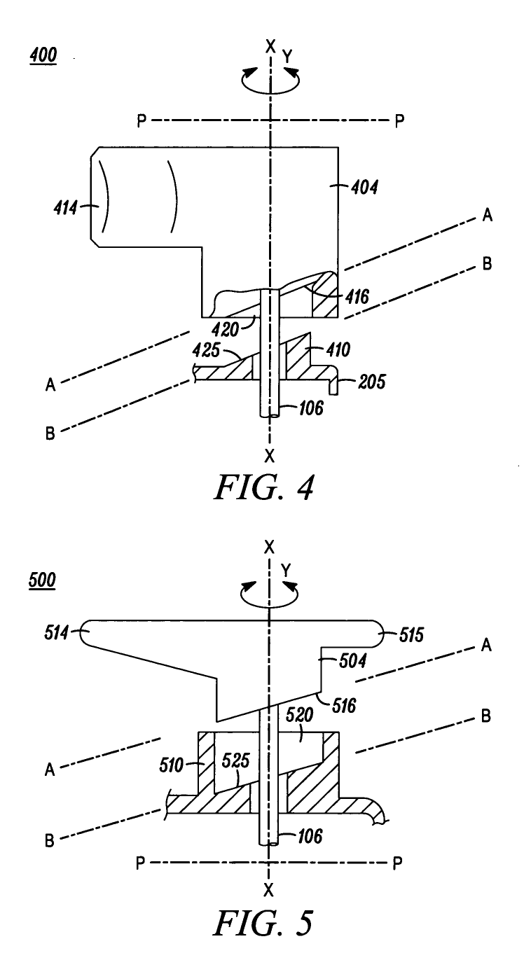

Referring to FIG. 4 there is illustrated another embodiment of part of an electronics device 400 in which a continuous first track 416 of and end cap 404 resides in a socket 420 and a continuous second track 425 of an end cap locator 410 forms part of a spigot for insertion into the socket 420. The end cap 404 has a lateral extending member 414 and thus end cap 404 is asymmetrical along axis X. All other components that are not shown are identical to that of device 200. During retraction to the retracted position the end cap 404 operatively engages the end cap locator 410 (e.g. the socket and spigot operatively engage) such that the continuous second track 425 that is complementary shaped to abut the continuous first track 416 co-acts when in abutting contact to provide a torque on linear radiating element 106. This torque is in the direction as illustrated by arrowed line Y and thereby performs aligning of the end cap 404 in a predetermined orientation relative to the housing 205. The aligning of the end cap in the predetermined orientation is complete when continuous second track 425 abuts the continuous first track 416 along its full length. In this specific embodiment, when retracted the alignment in the predetermined orientation ensures that the lateral extending member 414 does not protrude forwards or backwards.

Referring to FIG. 5 there is illustrated another embodiment of part of an electronics device 500 in which a continuous first track 516 of end cap 504 forms part of a spigot for insertion into a socket 520 with a continuous second track 525 of an end cap locator 510. The end cap 504 has a different sized lateral extending members 514, 515 and thus end cap 504 is asymmetrical along axis X. All other components that are not shown are identical to that of device 200. During retraction to the retracted position the end cap 504 operatively engages the end cap locator 510 such that the continuous second track 525 that is complementary shaped to abut the continuous first track 516 co-acts when in abutting contact to provide a torque on linear radiating element 106. This torque is in the direction as illustrated by arrowed line Y and thereby performs aligning of the end cap 504 in a predetermined orientation relative to the housing 205. The aligning of the end cap in the predetermined orientation is complete when continuous second track 525 abuts the continuous first track 516 along its full length. In this specific embodiment, when retracted the alignment in the predetermined orientation ensures that the lateral extending members 514, 515 does not protrude forwards or backwards.

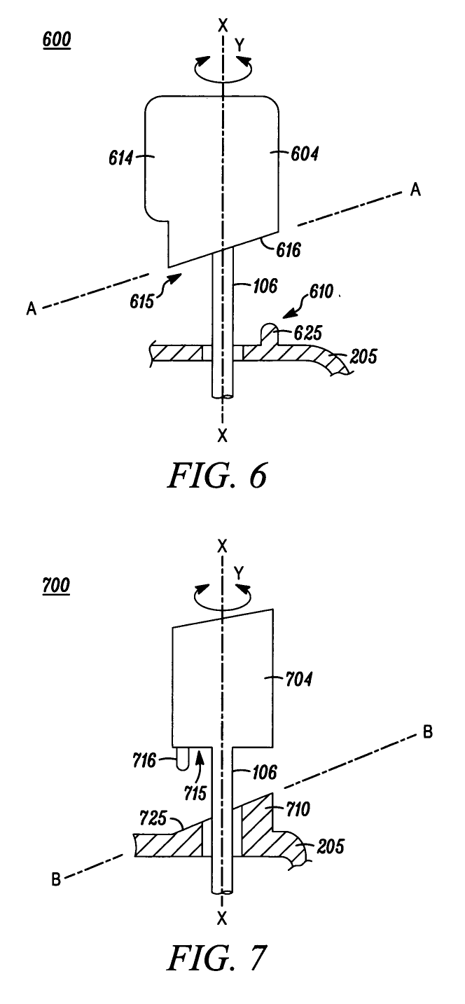

Referring to FIG. 6 there is illustrated another embodiment of part of an electronics device 600 in which a continuous first track 616 of and end cap 604 is located at a base portion 615 of end cap 604 and an end cap locator 610 comprises a protrusion 625 located substantially in proximity to an upper most point of the end cap locator 610. The end cap 604 has a lateral extending member 614 and thus end cap 604 is asymmetrical along axis X. All other components that are not shown are identical to that of device 200. During retraction to the retracted position the end cap 604 operatively engages the end cap locator 410 such that the continuous first track 616 co-acts when in abutting contact with protrusion 625 to provide a torque on linear radiating element 106. This torque is in the direction as illustrated by arrowed line Y and thereby performs aligning of the end cap 604 in a predetermined orientation relative to the housing 205.

Referring to FIG. 7 there is illustrated another embodiment of part of an electronics device 700 in which a protrusion of and end cap 704 is located at a base portion 715 of end cap 704 and an end cap locator 710 comprises a continuous second track 725. During retraction to the retracted position the end cap 604 operatively engages the end cap locator 410 such that the continuous second track 725 co-acts when in abutting contact with protrusion 716 to provide a torque on linear radiating element 106. This torque is in the direction as illustrated by arrowed line Y and thereby performs aligning of the end cap 604 in a predetermined orientation relative to the housing 205.

It will be apparent that other shaped, tracks and protrusions are envisaged and can include various cams or otherwise that provide a torque in the direction as illustrated by arrowed line Y during retraction of the antenna assembly 100. Advantageously, the present invention provides for ensuring that the antenna end cap is aligned in a pre-desired orientation when retracted into a housing of the device 200. This may assist in antenna sensitivity and also may have aesthetic appeal. The present invention could also allow for improving comfort to a user who wears such a device on their belt, thus if the end cap has protrusions then these protrusions can be aligned or oriented so that when the antenna assembly is retracted the protrusions to not dig into the user's torso,

In the foregoing specification, specific embodiments of the present invention have been described. However, one of ordinary skill in the art appreciates that various modifications and changes can be made without departing from the scope of the present invention as set forth in the claims below. For instance, the antenna assembly could be a retractable telescopic antenna assembly as will be apparent to a person skilled in the art. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. An electronic device comprising:
a housing with an end cap locator;
a retractable elongate radio frequency radiating element passing through an aperture associated with the end cap locator, the radiating element being electrically connected to an electrical circuit provided in the housing and being movable from a retracted position when substantially located in the housing to an extended position when substantially protruding outside the housing; and
an end cap located on a free end of the radiating element, the end cap operatively engaging the end cap locator when the radiating element is in the retracted position thereby aligning the end cap in a predetermined orientation relative to the housing.

2. The electronic device of claim 1, wherein the radiating element comprises a linear radiating element that is retractable and extendable along a central axis.

3. The electronic device of claim 1, wherein the end cap is provided with a continuous first track at its base portion.

4. The electronic device of claim 3, wherein the first track is in a plane that is traverse to the central axis and the first track is tapered at an angle to a plane that is normal to the central axis.

5. The electronic device of claim 1, wherein the end cap locator is provided with a continuous second track having complimentary shape to abut the first track along its full length when the end cap is in the predetermined orientation.

6. The electronic device of claim 5, wherein the second track is in a plane that is traverse to the central axis and the first track is tapered at an angle to a plane that is normal to the central axis.

7. The electronic device of claim 1, wherein the end cap locator is provided with a protrusion abutting the continuous first track when the end cap is in the predetermined orientation.

8. The electronic device of claim 7, wherein the protrusion an upper most part of the end cap locator.

9. The electronic device of claim 6, wherein the end cap is provided with a protrusion abutting the continuous second track when the end cap is in the predetermined orientation.

10. The electronic device of claim 9, wherein the protrusion is located substantially in proximity to a lower most point of the end cap.

11. The antenna assembly of claim 1, wherein the first track of the end cap is forms part of a spigot and the second track of the end cap locator resides in a socket.

12. The antenna assembly of claim 11, wherein the socket and spigot are operatively engage when the radiating element is in the retracted position.

13. The antenna assembly of claim 1, wherein a first track of the end cap resides in a socket and second track of the end cap locator forms part of a spigot.

14. The antenna assembly of claim 13, wherein the socket and spigot are operatively engage when the radiating element is in the retracted position.

15. The antenna assembly of claim 2, wherein the end cap is asymmetrical about the central axis.

16. The antenna assembly of claim 2, wherein during retracting of the radiator element the end cap operatively engages and co-acts with the end cap locator co-acts to provide a torque on the linear radiating element.
